(19) United States
(12) Patent Application Publication
(10) Pub. No.: US 2005/0016953 A1
(43) Pub. Date: Jan. 27, 2005

(54) Method of detecting particles and a processing apparatus using the same

(76) Inventors: Takeshi Arai, Yokohama (JP); Akira Kagoshima, Kudamatsu (JP); Hideyuki Yamamoto, Kudamatsu (JP); Daisuke Shiraishi, Kudamatsu (JP); Hiroyuki Nakano, Yokohama (JP); Toshihiko Nakata, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/790,180

(22) Filed: Mar. 2, 2004

(30) Foreign Application Priority Data
Jul. 22, 2003 (JP) 2003-199592

(51) Int. Cl. G01L 21/30

(52) U.S. Cl. 216/59

(57) ABSTRACT

A sample is processed while suppressing film deposition generated during plasma processing and fogging on a measurement window caused by etching to stably detect floating contaminants in a processing chamber with an improved contaminant capture rate. A particle detector is provided in the processing chamber, except for a space defined between electrodes of the plasma generator or a portion above the platform in which the plasma is generated. Laser light for scanning is emitted from the measurement window to the processing chamber, so that the particle detector detects scattered light from contaminants present in the processing chamber. The particle detector detects contaminants based on the detected scattered light during operation of the processing apparatus.

### BACKGROUND OF THE INVENTION

The present invention relates to a method of forming a thin film, a circuit pattern, and so forth, as desired, on a semiconductor substrate using plasma, such as by etching, sputtering, and CVD, and to an apparatus using the method. The invention particularly relates to: a method of processing a sample while detecting fine particles (contaminants) floating in the interior of a semiconductor manufacturing apparatus, such as a plasma processing apparatus; a processing apparatus with a particle detector; and a contaminant control system for controlling the detected contaminants. More specifically, the invention relates to a technology for measuring a contaminant occurrence state by measuring, on a real-time basis, the contaminants occurring in a processing chamber in the course of forming a thin film, a circuit pattern, and so forth, using plasma processing technology.

Conventionally, processing apparatuses using plasma, such as an etching apparatus, have widely been used for manufacturing semiconductors and liquid crystal display device substrates.

In plasma etching processing performed by such a processing apparatus using a plasma, for instance, the reaction products generated by the etching reaction are deposited on a wall or electrodes of a plasma chamber, and the reaction products are stripped of f in the course of time to become floating contaminants.

The floating contaminants, which have been trapped by the plasma before the start of etching and during the etching, tend to fall on the substrate provided for semiconductor processing when the discharge is stopped, and they adhere to the substrate. The contaminants which have adhered to the substrate cause etching defects, such as non-aperture, bad circuit characteristics, and a bad pattern appearance. Ultimately, the contaminants are responsible for reduction in the yield of the semiconductor elements and a deterioration in the reliability of the elements.

Thus, as a device for performing in-situ measurement of the contaminants floating in a plasma processing apparatus, a device has been proposed for detecting fine particles in the vicinity of a wafer in a semiconductor device manufacturing apparatus. This detecting device comprises a detector, including a light transmitter for transmitting a light beam to be emitted across a measurement volume; and an optical system for condensing scattered light from the measurement volume to direct the light to a photodetector, the detector being adapted to generate a signal representing the intensity of the light directed to the photodetector. This detecting device further comprises a signal processor including a pulse detector interconnected with the photodetector so as to analyze the signal from the photodetector and detect a pulse in the signal from the photodetector; and an event detector for identifying a series of pulses which is associated with the fine particles and is generated by the light scattered from the particles due to a plurality of light beam irradiations performed repeatedly during the period when the fine particles move in the measurement volume (see, for example Japanese Patent Laid-open No. 10-213539).

However, the detector disclosed in Japanese Patent Laid-open No. 10-213539 observes a partial region of the wafer using fixed laser light, and it has difficulty in measuring floating contaminants present in the plasma processing chamber.

Thus, as a method and a device for performing in-situ measurement of contaminants floating in the plasma processing chamber over the whole surface of a wafer, a particle monitoring method and a work processing device have been proposed. This technique involves emitting laser light vertically, horizontally, or vertically and horizontally, in the processing chamber and detecting the laser light that is scattered from the contaminants in the processing chamber to monitor contaminants in the processing chamber using the intensity of the detected laser light on a real time basis (see, for example, Japanese Patent Laid-open No. 9-243549).

Also, as a method for in-situ measuring contaminants floating in a plasma processing apparatus, a particle detection method for detecting exhausted contaminants by providing a particle detector in an exhaust passage of a vacuum processing device has been proposed (see, for example, Japanese Patent Laid-open No. 6-148059),

However, in the method disclosed in Japanese Patent Laid-open No. 6-148059, a particle detector 11c is disposed downstream of an exhaust passage 8, which is connected to an outlet 20, and a butterfly valve 9, as shown, for example, in FIG. 13, and so the contaminant measurement is performed at a location remote from the vacuum chamber and in an atmosphere different from that of the processing chamber. Therefore, it is difficult to correctly distinguish the contaminants in the processing chamber from the contaminants deposited and stripped in the exhaust passage; and, under a vacuum of several Pa, the contaminants are hardly brought to a sensor provided in the exhaust passage, so that the number of contaminants reaching to the exhaust passage is reduced, resulting in a decreased contaminant capture rate and a deteriorated detection accuracy.

Thus, in order to improve the contaminant detection accuracy as compared to that obtained by contaminant detection in the exhaust passage, a particle detection device has been proposed, including an exhaust spare room provided at an outlet formed in a vacuum chamber; an exhaust passage connected to the exhaust spare room; a laser light emitter for irradiating the exhaust spare room with laser light for detection; and a photodetector for detecting light reflected by contaminants (see, for example, Japanese Patent Laid-open No. 9-203704).

However, in the method and device disclosed in Japanese Patent Laid-open No. 9-243549, a particle detector lib is disposed at a measurement window 10 for measuring contaminants in a plasma generating space 13, which is disposed above a substrate in a processing chamber, as shown in, for example, FIG. 14. In this arrangement, the measurement window 10 for detecting the laser emission and the scattered light from contaminants is exposed to the plasma generating space, and film deposition and etching on the measurement window undesirably occur due to reaction products generated by the plasma and the etchant, thereby causing fogging on the measurement window, which results in deterioration of the detection sensitivity.

Also, the device disclosed in Japanese Patent Laid-open No. 9-203704 requires provision of the exhaust spare room at the outlet formed in the vacuum chamber, in addition to the processing chamber. Also, the number of the contaminants arriving at the exhaust spare room is small, as is the case with the exhaust passage, and only one point extending from the center axis on the exhaust passage is subjected to laser light detection. Therefore, problems including an insufficient contaminant capture rate and insufficient detection accuracy have been detected with this device as well.

### SUMMARY OF THE INVENTION

An object of the present invention is to provide a method of processing a sample while suppressing film deposition generated during plasma processing and fogging on a measurement window caused by etching so as to stably detect floating contaminants in a processing chamber with an improved contaminant capture rate, as well as an apparatus using the method.

Another object of the invention is to provide a contaminant control system which enables stable operation of a plasma processing apparatus by controlling the number of generated contaminants and which establishes a maintenance spot and a maintenance timing.

More specifically, according to one aspect of the invention, there is provided a method of processing a sample, comprising the steps of: supplying a process gas to a processing chamber; generating plasma using a plasma generator; and processing the sample placed on a platform using the plasma; wherein, in the sample processing step, a space in the processing chamber, except for a space defined between electrodes of the plasma generator or a portion above the platform in which the plasma is generated, is irradiated with laser light for scanning; wherein scattered light from contaminants present in the processing chamber is detected; and wherein the contaminants are detected based on the detected scattered light.

In accordance with another aspect of the invention, there is provided an apparatus for processing a sample, comprising: a processing chamber provided with a platform on which the sample is placed, the processing chamber being provided with a measurement window formed on a wall surface; evacuation means for evacuating the processing chamber; a gas injector for injecting a gas into the processing chamber; a plasma generator for generating plasma in the processing chamber after the processing chamber has been evacuated by the use of the evacuation means and the gas has been injected into the processing chamber by the use of the gas injector; and a particle detector for detecting scattered light generated from contaminants present in the processing chamber by irradiating and scanning, with laser light, a space which is defined in the processing chamber, but is outside a region where the plasma is generated, via the measurement window during processing of the sample placed on the platform with the plasma generated in the processing chamber by the use of the plasma generator.

In accordance with yet another aspect of the present invention, there is provided a plasma processing apparatus control system comprising: a plasma processing apparatus including a platform on which a sample is placed, a plasma generator, and a measurement window formed on a wall surface, the apparatus processing the sample placed on the platform with the plasma generated by the plasma generator; a particle detector for detecting scattered light generated from contaminants present in the plasma processing apparatus by irradiating and scanning, with laser light, a space which is defined in the processing apparatus, but is outside a region where the plasma is generated, via the measurement window of the processing apparatus during the plasma processing on the sample by the processing apparatus; and a controller for receiving a signal output from the processing apparatus and a detection signal from the particle detector to control the processing apparatus and contaminant data.

These and other objects, features, and advantages of the invention will be apparent from the following more particular description of preferred embodiments of the invention, as illustrated in the accompanying drawings.

### BRIEF DESCRIPTION OF THE DRAWINGS

FIG. 1 is a diagrammatic sectional view showing a particle detector provided in a parallel plate type etching apparatus according to a first embodiment of the present invention.

FIG. 2 is a diagrammatic sectional view illustrating an example of a laser scanning position of the particle detector according to the first embodiment of the invention.

FIG. 3 is a view showing a section taken along the line A-A′ of FIG. 2.

FIG. 4 is a diagrammatic sectional view illustrating another example of the laser scanning position of the particle detector according to the first embodiment of the invention.

FIG. 5 is a diagrammatic sectional view showing a particle detector provided in a parallel plate type etching apparatus according to a second embodiment of the invention.

FIG. 6 is a diagram showing captured contaminants according to the second embodiment of the invention.

FIG. 7 is a diagram showing captured contaminants according to the second embodiment of the invention.

FIG. 8 is a diagram showing captured contaminants according to the second embodiment of the invention.

FIG. 9 is a flowchart showing the operation of a processing apparatus according to a third embodiment of the invention.

FIG. 10 is a diagram illustrating the operation of a contaminant control system according to a fourth embodiment of the invention.

FIG. 11(a) is a side sectional view and FIG. 11(b) is a plan view illustrating the structure of a measurement window according to a fifth embodiment of the invention.

FIG. 12 is a sectional view taken along line B-B′ in FIG. 5 and illustrating the position of a particle detector according to a sixth embodiment of the invention.

FIG. 13 is a diagrammatic sectional view illustrating a conventional particle detector mounted on a processing apparatus.

FIG. 14 is a diagrammatic sectional view illustrating a conventional particle detector mounted on a processing apparatus.

### DESCRIPTION OF THE PREFERRED EMBODIMENTS

Hereinafter, embodiments of the present invention will be described in detail based on the drawings. In the drawings, identical component members are denoted by an identical reference numeral, and a repetitive description of such component members will be omitted.

(First Embodiment)

In this embodiment, a particle detector, which serves as an in-situ particle monitoring device for a parallel plate type plasma processing apparatus or a parallel plate type etching apparatus, will be described as an example.

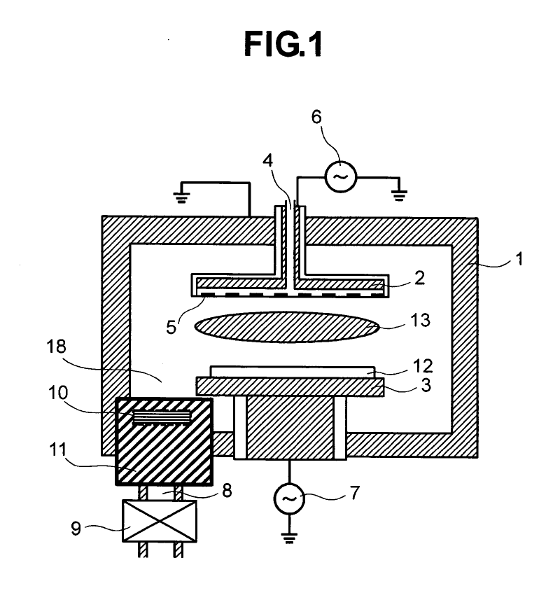

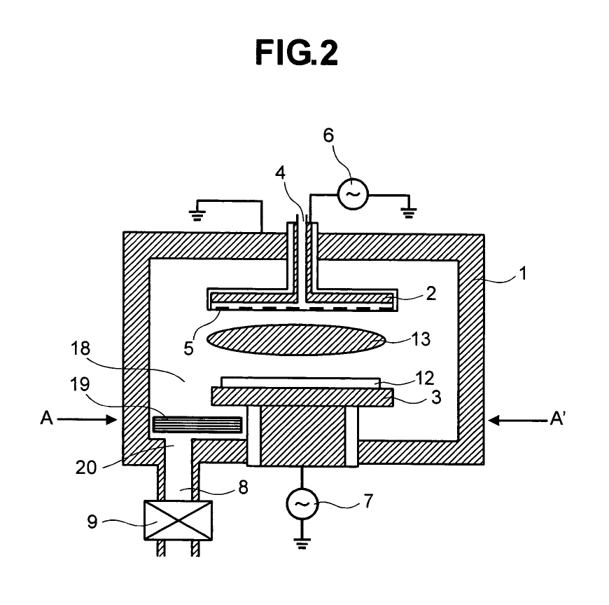

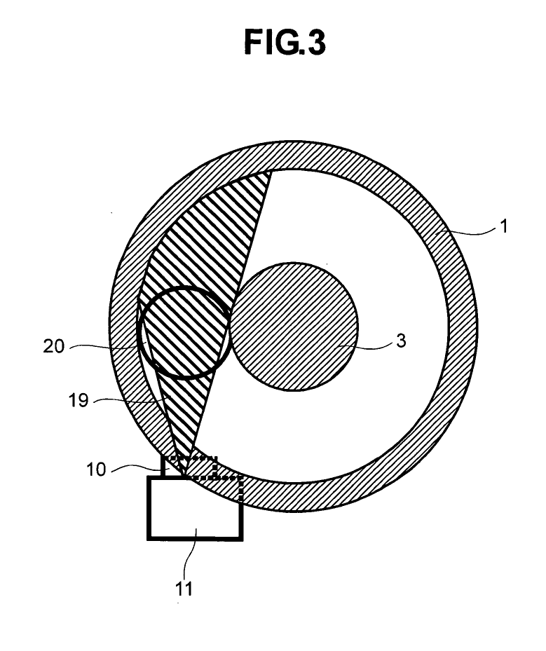

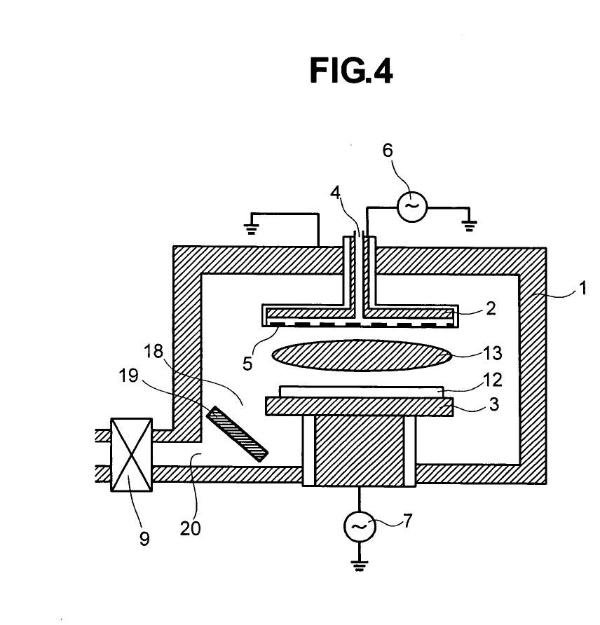

FIG. 1 shows the position of attachment of the particle detector in the parallel plate type etching apparatus according to this embodiment; FIG. 2 is a view illustrating an example of a laser scanning position of the particle detector according to this embodiment; FIG. 3 is a view showing a section taken along the line A-A′ of FIG. 2; and FIG. 4 is a view illustrating another example of the laser scanning position of the particle detector according to this embodiment.

Referring to FIG. 1, a processing chamber 1 constitutes a vacuum reactor that is capable of achieving a vacuum of about 10⁻⁴ Pa and has an upper electrode 2 and a lower electrode 3. A gas supply port 5 for injecting a process gas 4, such as an etching gas, is formed on the upper electrode 2, and a high frequency voltage from a radio frequency power supply 6 (RF power 13.56 MHz, for example) for generating plasma is applied to the upper electrode 2.

The lower electrode 3 has a structure such that a substrate 12 may be mounted thereon, and a bias control power supply 7 for controlling implanted ions is applied thereto.

The processing chamber 1 is continuously exhausted by the use of a turbo-molecular pump or the like through an exhaust passage 8, where the exhaust rate is adjusted by a butterfly valve 9.

A measurement window 10 is provided at an opening formed on a wall in a passage extending from the processing chamber 1, serving as the vacuum reactor, to the exhaust passage 8. A particle detector 11 is provided in such a manner as to monitor floating contaminants generated during etching processing, as well as in the processing chamber 1, through the measurement window 10.

The operation of this embodiment will be described hereinafter.

In the particle detector 11, laser light (the second harmonic of YAG: 532 nm, for example) is used for scanning the processing chamber using a scanner, such as a galvano mirror.

The substrate 12 on which the etching processing is performed is disposed on the lower electrode 3. The process gas 4 is regulated to an arbitrary value by the use of an MFC (Mass Flow Controller) or the like, and the pressure in the processing chamber 1 is adjusted to an arbitrary value, such as several Pa, so that plasma is generated in the processing chamber 1 when a high frequency voltage is applied from the high frequency power supply 6 to the upper electrode 2.

An etching gas, such as CF₄ and Cl₂, is used as the process gas 4, which is plasma-decomposed so that a thin film on the substrate 12 is etched by ions and neutral active species. During the etching, a process control is performed in such a manner that the particle detector 11 monitors contaminants generated during conveyance of the substrate 12 or during plasma processing through the measurement window 10.

The particle detector 11 scans a laser scanning region 19, as shown in FIGS. 2 and 3, for example, using the laser light, with the laser scanning region 19 being set in a direction orthogonal to the exhaust passage 18 (passage through which the gas flows) between the processing chamber 1 and the exhaust passage 8. That is to say, a section of the space where the contaminants are flowing is laser-scanned.

More specifically, the exhaust passage 18 above an exhaust port 20 is scanned in the laser scanning region 19 of the particle detector 11 to capture contaminants floating in the processing chamber 1. Further, scanning the laser scanning region 19 in a direction orthogonal to the gas flowing direction in the exhaust passage 18 increases the capture rate of contaminants flowing in or floating to the exhaust port 20. In addition, the laser scanning region 19, in a direction shown in FIG. 4, is effective based on the concept of scanning in a direction orthogonal to the exhaust passage 18.

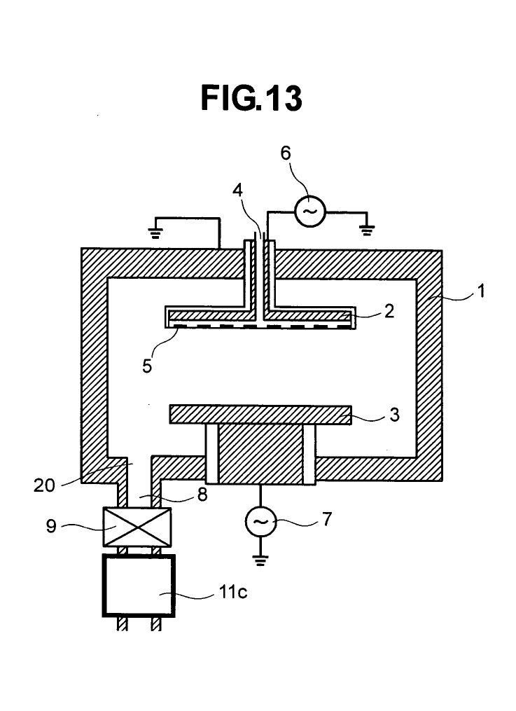

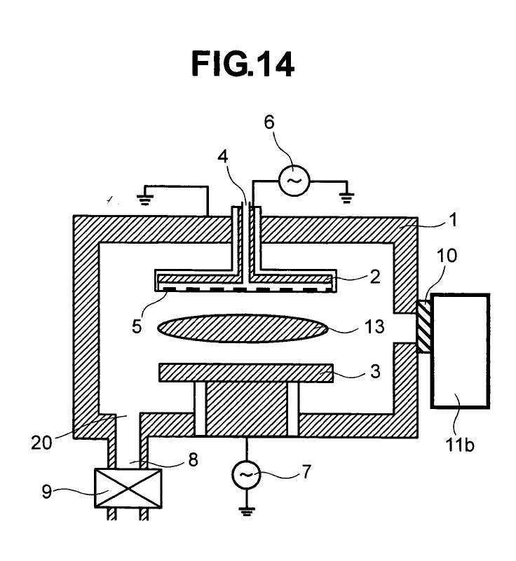

As described in the foregoing, the above-described problems, such as the reduction in contaminant capture rate and the deterioration in detection sensitivity due to fogging on the measurement window 10, have been encountered with the conventional examples, wherein a particle detector 11c is provided in the exhaust passage 8, as shown in FIG. 13, and a particle detector 11b is provided at a position for observing the plasma generating space 13 above the substrate 12, as shown in FIG. 14. However, the particle detector 11 is disposed on the exhaust passage 18 extending from the processing chamber 1 to the exhaust passage 8 in this embodiment, as shown in FIG. 1, thereby improving the contaminant capture rate and enabling effective contaminant detection with suppressed fogging on the measurement window 10 and without deterioration in the detection sensitivity.

(Second Embodiment)

In this embodiment, a particle detector which constitutes an in-situ particle monitoring device for a microwave plasma etching apparatus will be described as an example.

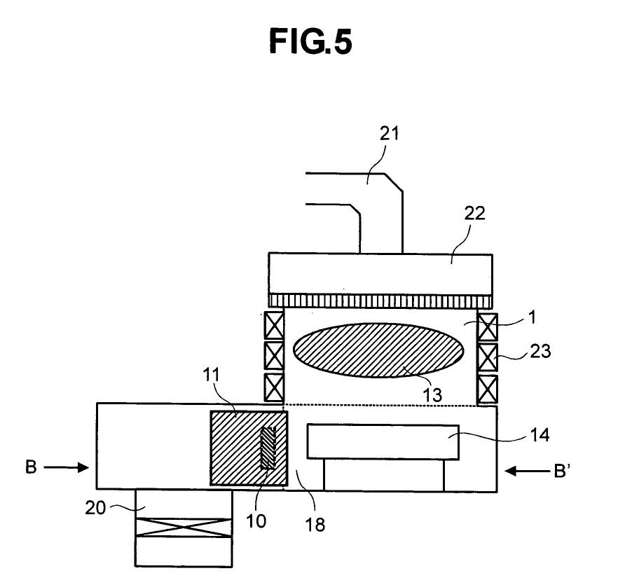

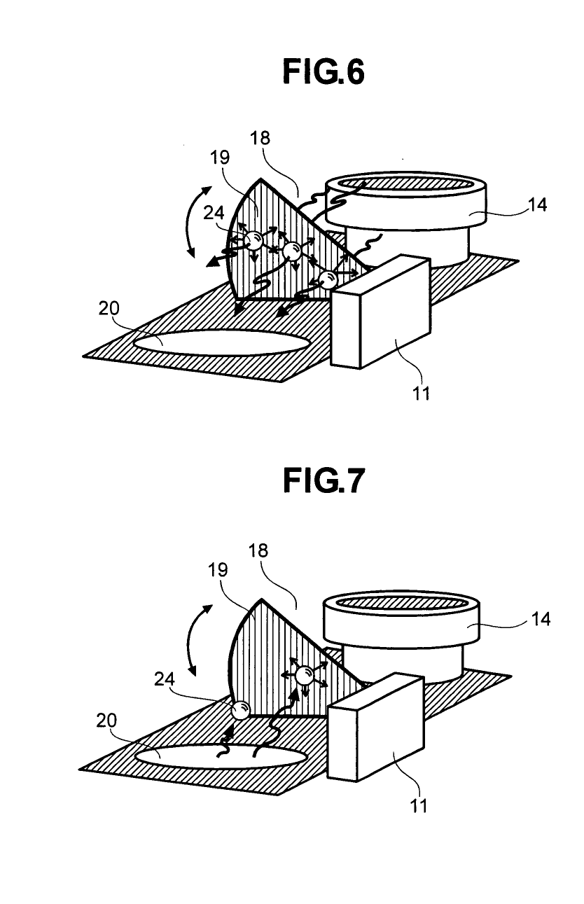

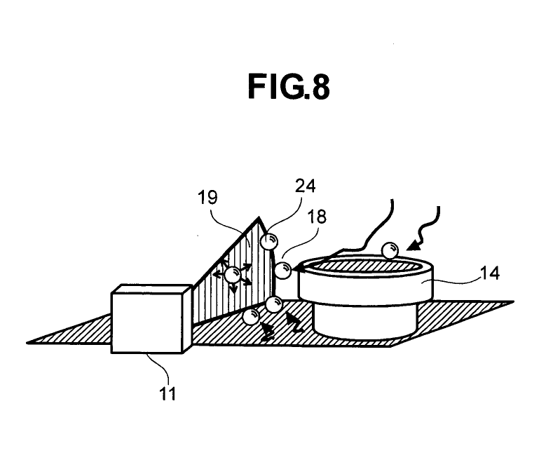

FIG. 5 is a sectional view showing the position of attachment of the particle detector in the parallel plate type etching apparatus according to the second embodiment, and FIGS. 6 to 8 are views each showing the capture of contaminants.

Referring to FIG. 5, the microwave plasma etching apparatus has an exhaust port 20 provided beside a processing chamber 1, and the particle detector 11 is placed in an exhaust passage 18 extending from the processing chamber to the exhaust port 20. With the microwave plasma etching apparatus, a microwave is transmitted through a wave guide 21 to generate plasma above a platform 14 in the processing chamber 1 via a quartz plate 22, and the plasma is controlled by an electromagnet 23 provided around the processing chamber 1.

For the processing apparatus where the electromagnet 23 is provided around the processing chamber 1, a measurement window 10 for the particle detector 11 formed in the plasma generating space 13 might exert an influence on the plasma generation state. As described in the foregoing, etching on the measurement window 10 progresses due to film deposition caused by reaction products and etchant when the measurement window 10 is exposed to the plasma generation space 13, which causes fogging on the measurement window 10 to deteriorate the detection sensitivity.

In this embodiment, by providing the particle detector 11 in the exhaust passage 18 extending from the processing chamber 1 to the exhaust port 20, as shown in FIG. 5, contaminants can be measured without exposing the measurement window 10 to the high density plasma generating space 13.

Further, with such an installation position of the particle detector 11 of this embodiment, a laser scanning region is set in such a manner that the scanned surface is orthogonal to a horizontal direction of the exhaust passage 18 extending from the processing chamber 1 to the exhaust port 20, thereby capturing contaminants flowing in the exhaust stream and contaminants floating in the processing chamber 1.

Hereinafter, the capturing of contaminants according to this embodiment will be described.

Contaminants 24 flowing from the processing chamber 1 to the exhaust port 20 are captured through the laser scanning region 19 in the exhaust passage 18. Since the contaminants 24 float without regard to the flow of the gas under a high vacuum of about a several Pa, it is important to capture the contaminants 24 at the time when the contaminants are floating, such as a trigger application time, including the introduction of a process gas and a start and a stop of a plasma discharge, so as to determine the contaminant generating state in the processing chamber 1.

Owing to the position of the particle detector 11 and the laser scanning method according to this embodiment, the probability of detecting the contaminants 24 is high even if the contaminants which have fallen in the processing chamber do not float upward to reach to the platform 14, as shown in FIG. 6.

Since the particle detector is placed between the exhaust port 20 and the processing chamber 1, it is possible to capture contaminants derived from the butterfly valve 9 before they reach to the platform 14, thereby enabling early detection of contaminants in the processing chamber 1 caused by the apparatus.

It is possible to obtain information on the scattered light generation position in the vertical direction as data owing to the laser scanning, thereby making it possible to distinguish among contaminants floating from the bottom in the processing chamber 1, contaminants that have fallen from a cover of the exhaust port 20 and an inner wall of the processing chamber 1, and contaminants flowing from a conveyance room when the substrate 12 is loaded.

(Third Embodiment)

The operation of a processing apparatus provided with the particle detector 11, such as the parallel plate type etching apparatus and the microwave plasma etching apparatus described in connection with the first and the second embodiment, will be described in this embodiment.

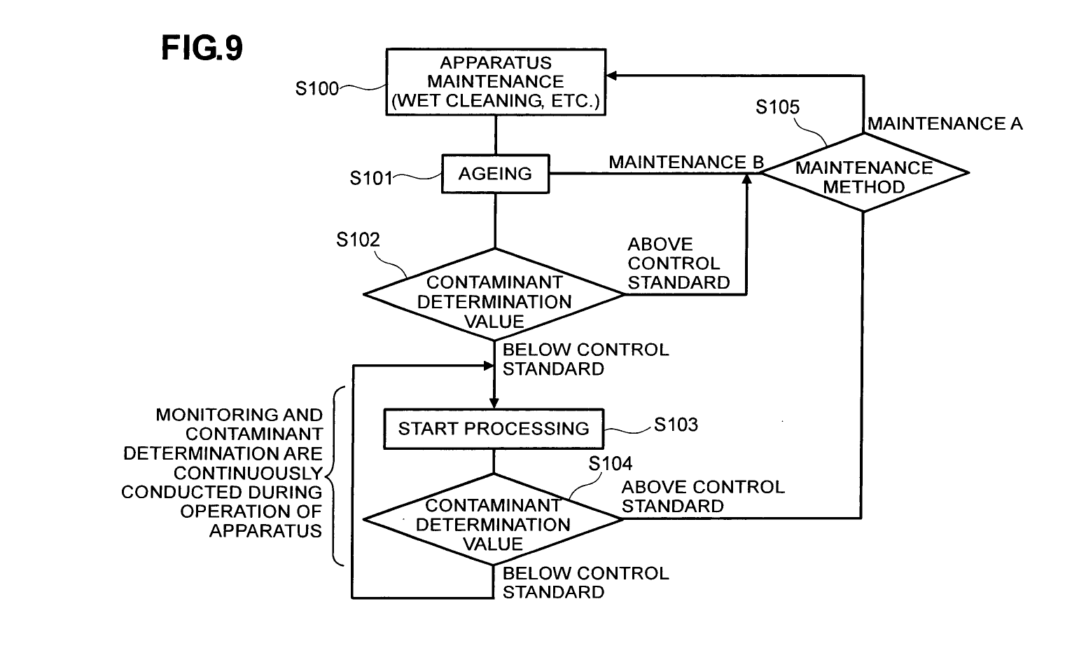

FIG. 9 is a flowchart showing the operation of the processing apparatus according to the third embodiment.

The processing apparatus, such as a parallel plate type etching apparatus and a microwave plasma etching apparatus, has the particle detector 11, which is provided in the exhaust passage 18 extending from the processing chamber 1 to the exhaust passage 8, as described in connection with the first and the second embodiment, and contaminants are continuously detected during the operation of the processing apparatus.

When the processing apparatus is in operation, a wet cleaning or the like is performed for apparatus maintenance (S100), and then aging or an in-situ plasma cleaning is performed (S101). The step S101 is repeated until the number of contaminants is found to be below a control standard of the contaminant detection, which is performed continuously by the particle detector 11 (S102).

When the number of contaminants is below the control standard in step S102, the processing apparatus starts various items of processing (S103). If the number of contaminants is found to be below the control standard in the continuous contaminant detection performed by the particle detector 11, the process returns to step S103 so that the processing is continued (S104).

When the number of contaminants is found to be above the control standard in step S104, a maintenance method is determined depending on the contaminant detection state (S105). When a maintenance A for performing wet cleaning is selected in step S105, the process returns to step S100. When a maintenance B for performing in-situ plasma cleaning is selected in step S105, the process returns to step S101 so that the rest of the processing is performed.

Thus, the particle detector 11 placed in the exhaust passage 18 which extends from the processing chamber 1 to the exhaust passage 8 detects the contaminants continuously during the operation of the processing apparatus. Thus, the contaminant detection can be performed without fail and the maintenance carried out during the operation of the processing apparatus can be properly performed.

(Fourth Embodiment)

In this embodiment, the operation of a contaminant control system using the processing apparatus provided with the particle detector 11, such as the parallel plate type etching apparatus and the microwave plasma etching apparatus as described in connection with the first and the second embodiment, will be described.

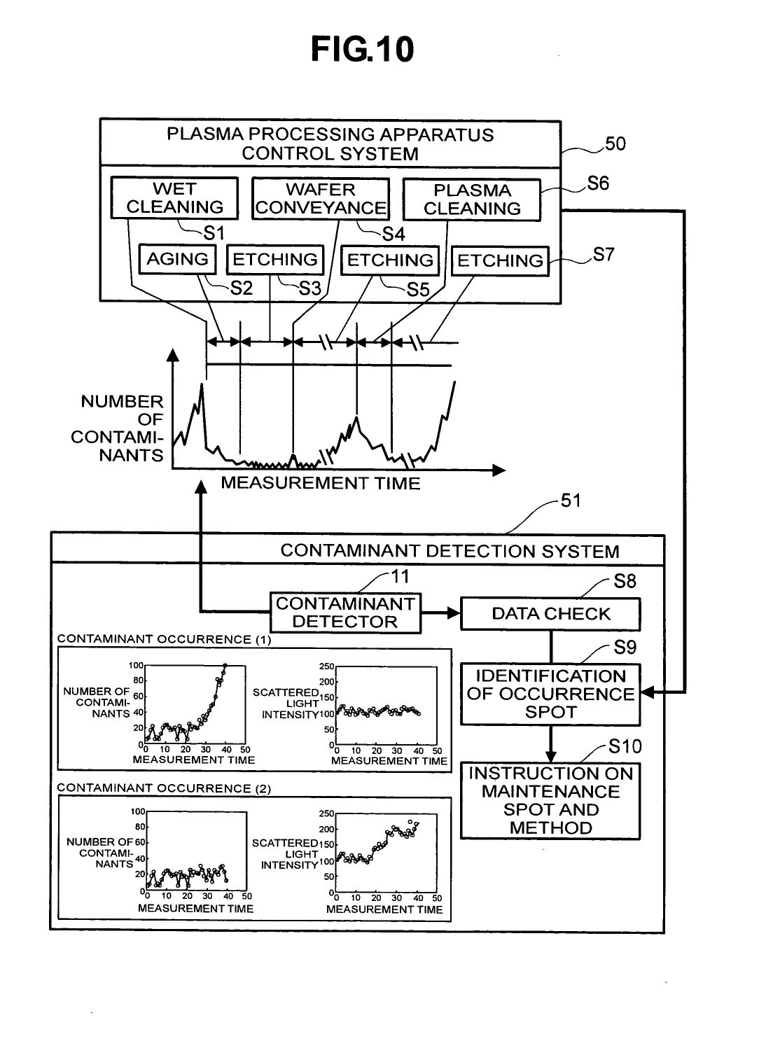

FIG. 10 is a diagram illustrating the operation of the contaminant control system according to this embodiment.

Referring to FIG. 10, the contaminant control system has a plasma processing apparatus control system 50 and a contaminant detection system 51, such that a contaminant generation state in the processing apparatus is controlled according to the number of contaminants detected by the particle detector 11.

The graph included in FIG. 10 shows an example of the fluctuation with measurement time in the number of contaminants, illustrating an operation state of the processing apparatus associated with the fluctuation.

When contaminants are increased in number, an instruction for wet cleaning is given from the contaminant control system so that the vacuum processing apparatus is opened to the air and wet cleaning is performed for apparatus maintenance (S1).

At the time when a predetermined vacuum and temperature are reached, an aging step is performed to stabilize the atmosphere inside the apparatus, while monitoring the reduction in the number of contaminants.

Then, upon performing a plasma etching process step (S3), an instruction for cleaning is given from the contaminant control system when the number of contaminants exceeds the contaminant control standard.

Since the state shown in FIG. 10 is an example of the measurement being below the contaminant control standard, a wafer is conveyed (S4). A contaminant measurement is performed during the wafer conveyance operation of the processing apparatus (S4). When the number of contaminants exceeds the control standard, the operation mechanisms of the processing apparatus during the conveyance, i.e., the gate valve opening/closing, and an arm conveyance chamber are assumed to be contaminant sources, so that the contaminant control system gives the instruction for cleaning.

Since the number of contaminants is below the contaminant control standard during the wafer conveyance operation in the example shown in FIG. 10, the instruction for cleaning is not given, but it is possible to detect the contaminant source by repeating the apparatus operation and to perform a contaminant countermeasure against the detected contaminant source.

The number of contaminants exceeds the contaminant control standard when the plasma etching process is performed (S5), and, accordingly, the contaminant control system gives an instruction to perform in-situ cleaning by plasma cleaning (S6).

The contaminant measurement is continued even during the in-situ cleaning by plasma cleaning, while the contaminant control system gives an instruction to start the etching process (S7). Thus, the contaminant control system measures the fluctuation in the number of contaminants and instructs the start of cleaning and the start of plasma processing.

The cleaning instruction is changed between the in-situ plasma cleaning instruction and the wet cleaning instruction depending on the contaminant generation state.

In the contaminant occurrence (1) shown in FIG. 10, when the number of contaminants continuously increases and the scattered light intensity is constant, fine contaminants have appeared; therefore, it is estimated that the contaminants were generated when a thin film deposited on an inner wall of the processing chamber 1 was etched. Accordingly, in-situ plasma cleansing is performed to remove the deposited film.

In the contaminant occurrence (2) shown in FIG. 10, the scattered light intensity increases, although the number of contaminants does not increase rapidly. In this case, it is highly probable that the amount of film deposited on the inner wall of the processing chamber I is great and large contaminants float due to stripping of the deposited film. Therefore, the maintenance to be carried out is wet cleaning. In the contaminant occurrence (2), a case wherein not only the scattered light intensity, but also the number of contaminants, possibly increases will occur.

The operation state of the processing apparatus is checked with the decision on the cleaning method simultaneously when the decision on the cleaning method is made (S8) such that a contaminant occurrence spot is identified (S9). Responding to the results, the contaminant control system gives instructions on the corresponding maintenance method and spot (S10).

In this embodiment, the contaminant control system performs the contaminant measurement when the processing apparatus is operated and gives instructions on the maintenance method and spot depending on the contaminant measurements and the operation state of the processing apparatus, thereby performing proper maintenance to realize a stable operation of the processing apparatus.

(Fifth Embodiment)

In this embodiment, the measurement window 10 has the shape of a slit and fogging on the measurement window 10 is suppressed.

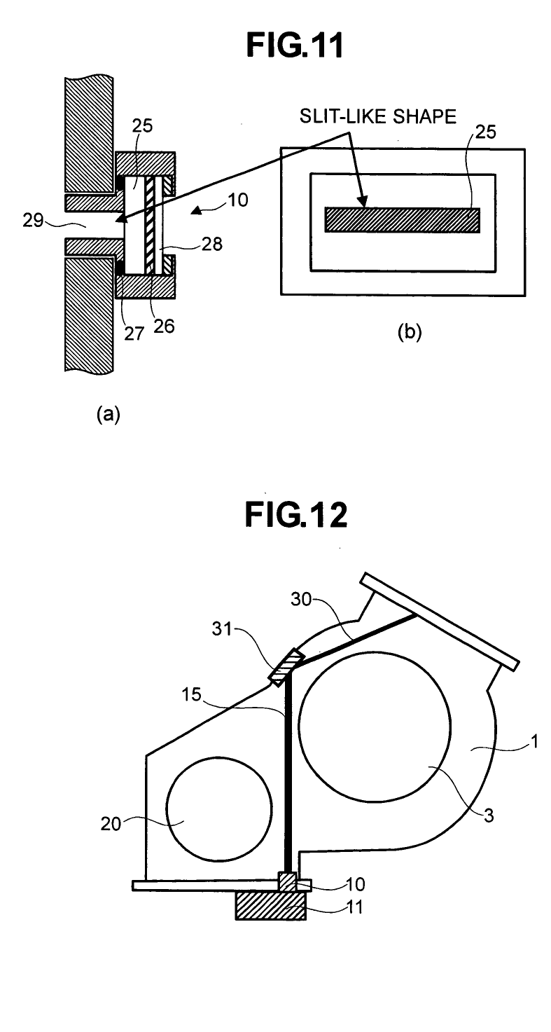

FIGS. 11(a) and 11(b) are a sectional view and a plane view showing the structure of the measurement window according to the fifth embodiment, respectively.

The particle detector 11 is disposed in an exhaust passage 18. This permits a long-term stable particle monitoring, as described in the foregoing. Since the particle detector 11 detects particles having the size of from a several microns to a submicron order, film deposition on the measurement window 10 caused by the etching processing and fogging on the measurement window 10 due to etching greatly influence the detection sensitivity.

In particular, scattered light from particles having a diameter of 0.25 μm or less is in the Rayleigh scattering region, and the intensity of the scattered light is in inverse proportion to the sixth power of the particle diameter. Therefore, the fogging on the measurement window 10 is crucial for detection of fine particles. That is to say, the sensitivity for detecting particles can be deteriorated to a large extent due to fogging on the measurement window 10 regardless of the excellent sensitivity of the particle detector 11. A change with time of the detection sensitivity is increased particularly when the measurement window 10 is exposed to plasma.

In terms of the above-described problems, this embodiment makes it possible to reduce the amount of reaction products generated due to plasma and the amount of etchant arriving at the measurement window 10 by placing the particle detector 11, not on the position between the electrodes or the platform, but on the space which is remote from the plasma generating space 13 and is between the processing chamber 1 and the exhaust passage 8. Further, it is possible to stably detect fine signals generated from the fine particles.

Also, in this embodiment, in order to further reduce the amounts of the reaction products and etchant reaching the measurement window 10, the measurement window 10 has a slit-like shape, as shown in FIG. 11(b).

The vacuum provided for the etching processing is about several Pa, which is under a low pressure condition, and the mean free path λ of the molecules is about several millimeters (in the case of Ar molecules at 25° C.). Therefore, a passage 29 extending from the processing chamber 1 is formed in such a manner that the height thereof is equal to or shorter than the mean free path, and the length thereof (directed from the processing chamber 1 to the measurement window 10) is equal to or longer than the mean free path.

Thus, the molecules adhere to an inner wall of the slit with a probability that is higher than that with which the molecules reach the measurement window. Accordingly, owing to this proper slit dimension, the probability of the reaction products and the etchant reaching to the window 25 can be reduced. In order to enhance this effect, it is desirable to reduce the height and the width of the slit as much as possible and to increase the length of the slit in a depth direction as much as possible.

Thus, the particle detector 11 is placed at a position remote from the plasma generating space 13, and the fogging on the window 25 is suppressed by reducing the probability of the reaction products and the etchant reaching the window 25. As a result, the change with time of the window 25 due to plasma is suppressed, and a stable, highly accurate monitoring is achieved.

Also, in order to prevent the microwaves from leaking through the measurement window 10, it is desirable to use a transparent electroconductive film. More specifically, the window 25, which is a transparent member made from glass or a sapphire substrate, is coated with a transparent electroconductive film 26, such as ITO (indium tin oxide) or ZnO (zinc oxide), to form the measurement window 10 attached to the plasma processing apparatus.

The coating surface is on the outside of the plasma processing apparatus, i.e., faces the monitoring side, while the surface facing the interior of the processing chamber 1 is a clean surface without a coating. The thus-obtained measurement window 10 has a transparency of 80% transmittivity or more in the visual area and is capable of maintaining the detection sensitivity of an optical monitoring device, such as a particle monitor.

The coating film has a resistance of 10⁴ Ω·cm or less, and it serves as an electroconductive part. This coating film is connected to the plasma processing apparatus to make the potential of the coating film the same as that of the plasma processing apparatus, which prevents the electromagnetic waves from leaking from the plasma generating space 13 and from influencing the sensor and the human body.

The window 25 should have a thickness and material sufficient to endure a high vacuum (at least 10⁻⁴ Pa). For this purpose, the window 25 is fixed to the measurement window 10 using an O-ring 27. The material of the window 25 is selected depending on the measurement wavelength range. In order to further avoid etching of the window due to the chemical reaction of the etchant in the plasma processing, a sapphire glass which well endures etching is favorably used for the window 25.

Also, in this embodiment, it is desirable to subject the window 25 to a low reflection surface coating, such as a black alumite processing, so as to prevent the scattered light caused by the laser light reflecting from the inner wall of the measurement window 10 from influencing the detection. In order to prevent the reflection of the laser light from influencing the detection, the window 25 is provided with a reflection prevention film 28, which is formed on the transparent electroconductive film 26 at the laser incident side.

Also, the particle detector 11 of the invention is provided in an optical detection system with a space filter for shielding the reflected light from the inner wall of the processing chamber, thereby to suppress the influence of the reflected light on the detection.

(Sixth Embodiment)

In this embodiment, a particle detector 11 is so disposed as not to be orthogonal to an inner wall of a vacuum processing apparatus which is irradiated with laser light 15, thereby avoiding intensely reflected light from a wall opposite the particle detector 11.

FIG. 12 is a view illustrating the position of the particle detector according to the sixth embodiment, wherein a section taken along the line B-B′ in FIG. 5 is shown.

Since the position of the particle detector 11 is subjected to less influence by the plasma generation, it is possible to change the position of the particle detector 11 depending on the optical characteristics and the shape of the processing chamber 1, which is irradiated with the laser light.

For example, as shown in FIG. 12, the particle detector 11 is so disposed as not to be orthogonal to the vacuum processing apparatus inner wall 31, which is irradiated with the laser light 15. Alternatively, the shape of an inner wall of the particle detector 11 can be so changed as not be orthogonal to the vacuum processing apparatus inner wall 31.

With the above-described constitution, it is possible to avoid the intensely reflected light from the wall opposite the particle detector 11 and to guide the reflected light 30, not to the particle detector 11, but in another direction.

Also, in the case where the inner wall of the processing chamber 1 is made from a high reflection material, such as stainless metal and aluminum, the following stray light countermeasures may be taken: performing black alumite processing on a laser irradiation portion of the inner wall; and use of a material capable of absorbing the laser light wavelength for forming the laser irradiation portion.

In addition, although the first to sixth embodiments are directed to the etching process, it is possible to apply the contaminant detection method of the invention to processes, such as sputtering and plasma CVD.

Also, although the first to sixth embodiments are described by taking the in-situ particle detector using backward scattered light as an example, the invention is not limited thereto. The same effect is achieved in photodetection methods using forward scattered light or laterally scattered light, although a plurality of windows are required.

As described in the foregoing, according to the present invention, the particle detector is placed for measurement between the electrodes in the plasma processing apparatus, i.e., in the processing chamber for generating plasma, other than the portion on the platform, such as a space defined between the processing chamber and the exhaust passage. As a result, fogging on the measurement window can be suppressed, and, accordingly, floating contaminants in the processing chamber can be detected stably, leading to improvement in the contaminant capture rate.

Also, according to the present invention, the contaminant control system gives instructions on the maintenance spot, time, and cleaning method, thereby enabling the plasma processing apparatus to perform stable operation.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A method for processing a sample, comprising the steps of:
supplying a process gas to a processing chamber;
generating plasma using a plasma generator; and
processing the sample placed on a platform using the plasma;
wherein, in the sample processing step, a space in the processing chamber except for a space defined between electrodes of the plasma generator or a portion above the platform in which the plasma is generated is irradiated with laser light for scanning;
wherein scattered light from contaminants present in the processing chamber is detected; and
wherein the contaminants are detected based on the detected scattered light.

2. The method according to claim 1, wherein the space irradiated with the laser light for scanning is a space defined between the processing chamber and an exhaust passage.

3. The method according to claim 2, wherein the laser scanning is performed in such a manner that a scanned surface is orthogonal to a direction of exhaust along which the process gas or contaminants flow from the processing chamber to the exhaust passage.

4. The method according to claim 1, wherein the laser light is emitted from a position which is not orthogonal to an inner wall of the processing chamber to be irradiated with the laser light.

5. An apparatus for processing a sample, comprising:
a processing chamber provided with a platform on which the sample is placed, the processing chamber being provided with a measurement window formed on a wall surface;
evacuation means for evacuating the processing chamber;
gas injector for injecting a gas into the processing chamber;
a plasma generator for generating plasma in the processing chamber after the processing chamber has been evacuated by the use of the evacuation means and the gas has been injected into the processing chamber by the use of the gas injector; and
a particle detector for detecting scattered light generated from contaminants present in the processing chamber by irradiating and scanning, with laser light, a space which is defined in the processing chamber but is outside a region where the plasma is generated via the measurement window during processing the sample placed on the platform with the plasma generated in the processing chamber by the use of the plasma generator.

6. The apparatus according to claim 5, wherein the measurement window is provided in a space defined between the processing chamber and an exhaust passage.

7. The apparatus according to claim 6, wherein the laser scanning is performed by the particle detector in such a manner that a scanned surface is orthogonal to a direction of exhaust along which the gas or the contaminants flow from the processing chamber to the exhaust passage.

8. A plasma processing apparatus control system comprising:
a plasma processing apparatus including a platform on which a sample is placed, a plasma generator, and a measurement window formed on a wall surface, the apparatus processing the sample placed on the platform with the plasma generated by the plasma generator;
a particle detector for detecting scattered light generated from contaminants present in the plasma processing apparatus by irradiating and scanning, with laser light, a space which is defined in the processing apparatus but is outside a region where the plasma is generated via the measurement window of the processing apparatus during the plasma processing on the sample by the processing apparatus; and
a controller for receiving a signal output from the processing apparatus and a detection signal from the particle detector to control the processing apparatus and contaminant data.

9. The plasma processing apparatus control system according to claim 8, wherein the controller compares the output signal from the processing apparatus with a timing of the contaminant detection by the particle detector to identify a contaminant source in the processing apparatus.

10. The plasma processing apparatus control system according to claim 8, wherein the controller controls contaminants depending on signal intensity of the scattered light and the number of scattered light generations from the contaminants detected by the particle detector, and instructs a maintenance timing and a maintenance method depending on the signal intensity of the scattered light and the number of scattered light generations.
